(19) United States
(12) Patent Application Publication
(10) Pub. No.: US 2017/0054353 A1
(43) Pub. Date: Feb. 23, 2017

(54) Power Tool with Single Phase Brushless Motor

(71) Applicant: Johnson Electric S.A., Murten (CH)

(72) Inventors: Yue LI, Hong Kong (CN); Jing Ning TA, Hong Kong (CN); Chui You ZHOU, Shenzhen (CN); Qiu Mei LI, Shenzhen (CN); Yong WANG, Shenzhen (CN); Ming CHEN, Shenzhen (CN); Hong Liang YI, Shenzhen (CN); Tao ZHANG, Shenzhen (CN); Kwong Yip POON, Hong Kong (CN); Jie CHAI, Shenzhen (CN); Wen Liang LI, Shenzhen (CN); Lin Ping GUI, Shenzhen (CN)

(21) Appl. No.: 15/240,343

(22) Filed: Aug. 18, 2016

(30) Foreign Application Priority Data
Aug. 18, 2015 (CN) 2015 1050 7014.7
Apr. 8, 2016 (CN) 2016 1021 9185.4
Jul. 7, 2016 (CN) 2016 1053 8811.6

(51) Int. Cl. H02K 19/04; H02K 1/27; H02K 1/14

(52) U.S. Cl. CPC H02K 19/04; H02K 1/146; H02K 1/2706

(57) ABSTRACT

A power tool includes a main body and a working portion. The working portion is rotatably coupled to the main body. A single phase brushless motor is mounted in the main body to drive the working portion to rotate bidirectionally. In comparison with a traditional motor, the single phase brushless motor make the power tool has a reduced size and reduced cost while ensuring the stable performance.

### CROSS REFERENCE TO RELATED APPLICATIONS

This non-provisional patent application claims priority under 35 U.S.C. §119(a) from Patent Application No. 201510507014.7 filed in The People's Republic of China on 18 Aug. 2015, Patent Application No. 201610219185.4 filed in The People's Republic of China on 8 Apr. 2016, and Patent Application No. 201610538811.6 filed in The People's Republic of China on 7 Jul. 2016.

### FIELD OF THE INVENTION

The present invention relates to power tools, and in particular to power tools with single phase brushless motors.

### BACKGROUND OF THE INVENTION

Typically, an universal motor is used in a power tool. However, the universal motor is big and heavy, and needs a lot of windings, which make the power tool be big, heavy, and high cost.

### SUMMARY OF THE INVENTION

Thus, there is a desire for a power tool which is light and cheap.

A power tool comprises a main body and a working portion rotatably coupled to the main body. A single phase brushless motor is mounted in the main body to drive the working portion to rotate bidirectionally.

Preferably, the single phase brushless motor has the same bidirectional startup capabilities.

Preferably, the single phase brushless motor comprises a stator and a rotor, the stator comprises a stator core and windings wound around the stator core, the stator core comprises an outer yoke portion and at least two teeth extending inward from the outer yoke portion, a concave arc surface is formed on a radial inner end of each tooth, the arc surfaces of the teeth cooperatively bound a cavity for receiving the rotor, a positioning groove is defined in a circumferential center of each arc surface, and each poisoning groove locates on a center line of the corresponding tooth.

Preferably, an opening or a magnetic bridge is formed between each two adjacent teeth, a connecting line connecting a center of the rotor and a center of the opening or magnetic bridge, and an extension direction of one of the teeth form an angle of 60-90 degrees.

Preferably, the circumferential width of each tooth is 0.8-1.6 times of the outer diameter of the rotor, the diametrical thickness of the outer yoke portion is 0.3-0.7 times of the outer diameter of the rotor.

Preferably, the single phase brushless motor has different bidirectional startup capabilities.

Preferably, the single phase brushless motor comprises a stator and a rotor, the stator comprises a stator core and windings wound around the stator core, the stator core comprises an outer yoke portion and at least two teeth extending inward from the outer yoke portion, a concave arc surface is formed on a radial inner end of each tooth, the arc surfaces of the teeth cooperatively bound a cavity for receiving the rotor, a positioning groove is defined in each arc surface, each poisoning groove deviates from a center line of the corresponding tooth.

Preferably, the single phase brushless motor comprises a stator and a rotor, the stator comprises a stator core and windings wound around the stator core, the stator core comprises an outer yoke portion and at least two teeth extending inward from the outer yoke portion, a concave arc surface is formed on a radial inner end of each tooth, the arc surfaces of the teeth cooperatively bound a cavity for receiving the rotor, a circumferential center of each arc surface deviates from a center line of the corresponding tooth.

Preferably, a positioning groove is defined in each arc surface, and each poisoning groove locates on a center line of the corresponding tooth.

Preferably, the single phase brushless motor comprises a stator and a rotor, the stator comprises a stator core and windings wound around the stator core, the stator core comprises an outer yoke portion and at least two teeth extending inward from the outer yoke portion, a concave arc surface is formed on a radial inner end of each tooth, the arc surfaces of the teeth cooperatively bound a cavity for receiving the rotor, a substantially even air gap is defined between the rotor and the arc surfaces of the teeth.

Preferably, an opening is defined between each two adjacent teeth, and a width of each opening is less than or equal to three times of the width of the even air gap.

Preferably, the single phase brushless motor comprises a stator and a rotor, the stator comprises a stator core and windings wound around the stator core, the stator core comprises an outer yoke portion and at least two teeth extending inward from the outer yoke portion, a concave arc surface is formed on a radial inner end of each tooth, the arc surfaces of the teeth cooperatively bound a cavity for receiving the rotor, a symmetrical uneven air gap is defined between the rotor and the arc surfaces of the teeth.

Preferably, an opening is defined between each two adjacent teeth, and a width of each opening is less than or equal to three times of the width of the uneven air gap.

Preferably, the single phase brushless motor comprises a stator and a rotor, the stator comprises a stator core, the stator core comprises a first tooth and a second tooth opposite to each other along a diametrical direction of the rotor, a first arc surface is formed on a radial inner end of the first tooth, a second arc surface is formed on a radial inner end of the second tooth, a first cutting surface and a second cutting surface are formed on opposite circumferential ends of the first arc surface, a third cutting surface and a fourth cutting surface are formed on opposite circumferential ends of the second arc surface, a first opening is defined between the first cutting surface and the third cutting surface, and a second opening is defined between the second cutting surface and the fourth cutting surface, the first, second, third, and fourth cutting surfaces are perpendicular or slanted relative to the extension direction of the teeth.

Preferably, the power tool is an electric drill.

The power tool of the present invention includes a single blushless motor. In comparison with a traditional motor, the single phase brushless motor make the power tool has a reduced size and reduced cost while ensuring the stable performance.

### BRIEF DESCRIPTION OF THE DRAWINGS

FIG. 1 is a sketch map of a power tool according to a first embodiment of the present invention.

FIG. 2 is an assembled, perspective view of a single phase motor of the power tool of FIG. 1.

FIG. 3 is a cross sectional view of the single phase motor of FIG. 2.

FIG. 4 is a top plan view of a stator core and a rotor of the single phase motor of FIG. 2.

FIG. 5 is an exploded view of the rotor of the single phase motor of FIG. 2.

FIG. 6 is an exploded view of a first fixing bracket, a second bracket and the stator core of the single phase motor of FIG. 2.

FIG. 7 is an exploded view of an insulating bracket and windings of the single phase motor of FIG. 2.

FIG. 8 is a top plan view of a stator and a rotor of a single phase motor according to a second embodiment of the power tool.

FIG. 9 is a top plan view of a stator core of the single phase motor of FIG. 8.

FIG. 10 is a top plan view of a stator core and a rotor of a single phase motor according to a third embodiment of the power tool.

### DETAILED DESCRIPTION OF THE PREFERRED EMBODIMENTS

Below, the present invention will be described further in conjunction with embodiments illustrated in the drawings.

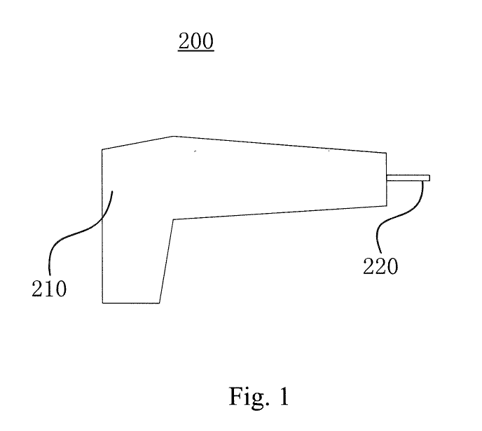

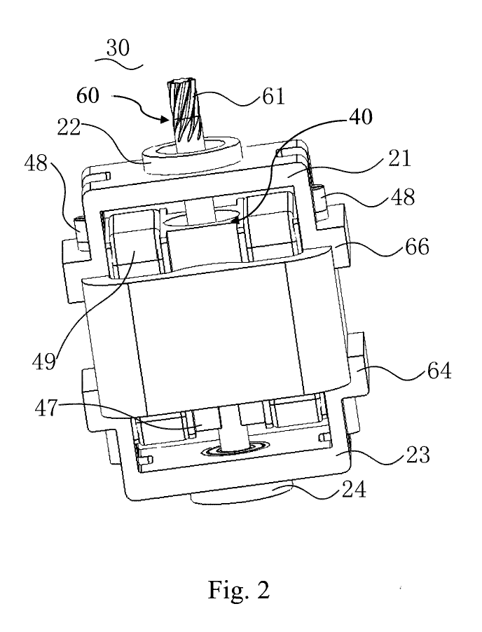

Referring to FIG. 1, a power tool 200 in accordance with a first embodiment of the present invention includes main body 210 and a working portion 220. A motor 30 (as shown in FIG. 2) is mounted in the main body 210 for actuating the working portion 220. In at least one embodiment, the power tool 200 is an electric drill.

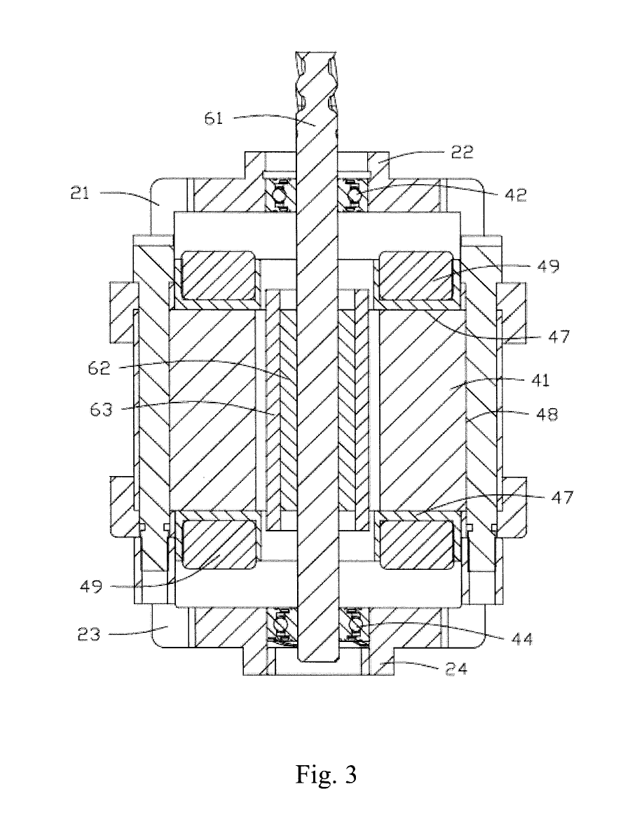

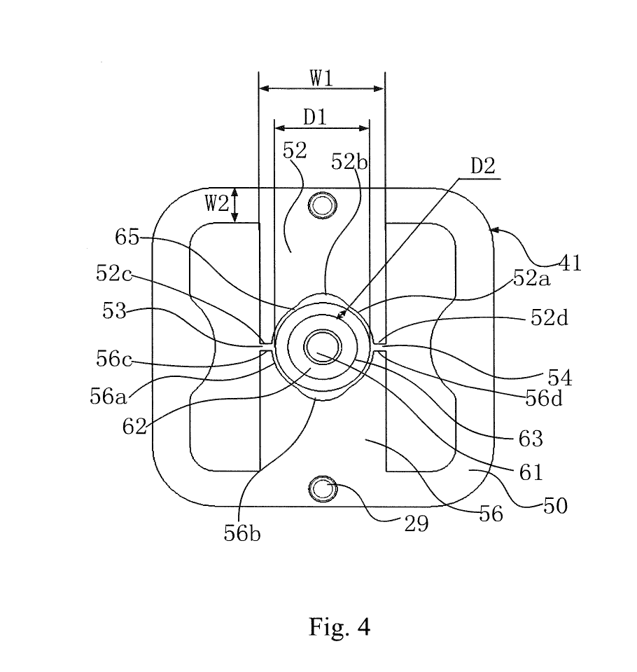

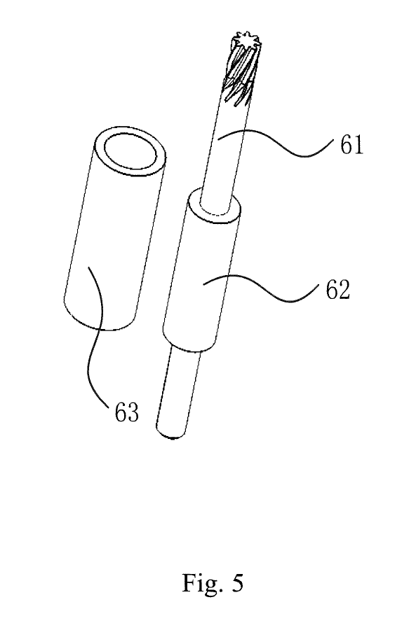

Referring to FIGS. 2 to 5, the motor 30 in accordance with one embodiment of the power tool 200 is a single phase brushless motor. The motor 30 includes a stator 40 and a rotor 60.

The rotor 60 includes a rotary shaft 61, a rotor core 62 placing around the rotary shaft 61, and a permanent magnet 63 placing around the rotor core 62. The permanent magnet 63 is an integrally formed annular permanent magnet. In other embodiments, the permanent magnet 63 may include a plurality of magnets, and the permanent magnet 63 can be fixed to the rotary shaft 61 directly. Preferably, a radial thickness D2 of the permanent magnet 63 is 0.2-0.24 times of an outer diameter D1 of the rotor 60.

The stator 40 includes a stator core 41 and windings 49 wound around the stator core 41. The stator core 41 includes an outer yoke portion 50, and a plurality of teeth extending from the outer yoke portion 50 toward a center of the stator core 41. In the embodiment, the teeth consists of a first tooth 52 and a second tooth 56. The first tooth 52 and the second tooth 56 have a width W1 perpendicular to the extension direction of the first tooth 52 and the second tooth 56, and the width W1 is 0.8-1.6 times of the outer diameter D1 of the rotor 60. The outer yoke portion 50 is a rectangular frame, the outer yoke portion 50 has a thickness W2 along a radial direction of the stator 40, and the thickness W2 is 0.3-0.7 times of the outer diameter D1 of the rotor 60.

An arc surface is formed on an inner end of each tooth in the radial direction of the tooth. The first tooth 52 includes a concave first arc surface 52a facing toward the rotor 60, and the second tooth 56 includes a concave second arc surface 56a facing toward the rotor 60. The first arc surface 52a and the second arc surface 56a face to each other to bound a receiving cavity therebetween for receiving the permanent magnet 63.

A first opening 53 and a second opening 54 with great magnetic resistance are defined between the first tooth 52 and the second tooth 56 at opposite sides of the permanent magnet 63. A first cutting surface 52c and a second cutting surface 52d are formed on opposite circumferential ends of the first arc surface 52a. A third cutting surface 56c and a fourth cutting surface 56d are formed on opposite circumferential ends of the second arc surface 56a. The first opening 53 is defined between the first cutting surface 52c and the third cutting surface 56c, and the second opening 54 is defined between the second cutting surface 52d and the fourth cutting surface 56d. Preferably, the first opening 53 and the second opening 54 are substantially the same in size and are symmetrical about the center of rotation of the rotor 60. A connecting line connecting the centers of the first opening 53, the second opening 54 and the center of the rotor 60, and the extension direction of one of the first tooth 52 and the second tooth 56 form an angle of 60-90 degrees. In this embodiment, the angle is 90 degree, the connecting line connecting the centers of the first and second openings 53 and 54 perpendicular to the extension direction of the first tooth 52 and the second tooth 56. The first cutting surface 52c, the second cutting surface 52d, the third cutting surface 56c and the fourth cutting surface 56d are perpendicular to the extension direction of the first and second teeth 52 and 56.

The first tooth 52 defines a first positioning groove 52b in the first arc surface 52a. The second tooth 56 defines a second positioning groove 56b in the second arc surface 56a. The first positioning groove 52b and the second positioning groove 56b face to each other along a diametrical direction of the rotor 60, for controlling the initial/stop position of the rotor 60 relative to the stator 40 when the motor 30 is de-energized. The stop position or initial position of the rotor 60 can be adjusted by adjusting the positions of the first and second positioning grooves 52b and 56b. Openings of the first and second positioning grooves 52b and 56b face toward the permanent magnet 63. A line connecting centers of the first and second positioning grooves 52b and 56b coincides with center lines of the first and second teeth 52 and 56. The motor 30 has the same bidirectional startup capabilities. In other embodiments, the positioning grooves can be defined deviating from center lines of the teeth, to make the rotor 60 have different bidirectional startup capabilities.

Preferably, the first arc surface 52a and the second arc surface 56a are located on a cylindrical surface that is coaxial with the rotor, such that a substantially even air gap 65 is defined between the permanent magnet 63 and the first and second arc surfaces 52a and 56a (except for the areas of the first and second positioning grooves 52b and 56b, and the first and second openings 53 and 54, the air gap at other areas is even). A width of each of the first and second openings 53 and 54 along a direction perpendicular to the extending direction of the first and second teeth 52 and 56 is less than or equal to three times of the thickness of the even gap 65. In this embodiment, a circumferential center of the first arc surface 52a locates on the symmetry center line of the first tooth 52, a circumferential center of the second arc surface 56a locates on the symmetry center line of the second tooth 56, the first and second arc surfaces 52a and 56a are respectively symmetrical about symmetry center lines of the first and second teeth 52 and 56.

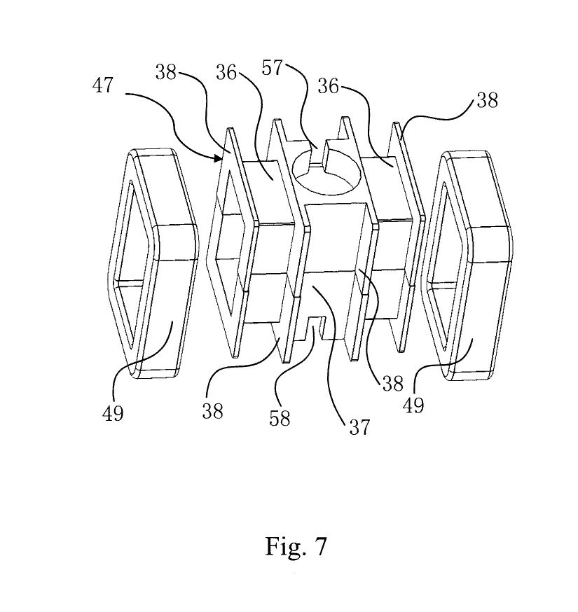

Referring to FIGS. 2, 3, 6 and 7, the windings 49 are wound around the first and second teeth 52 and 56, and the windings 49 can produce two magnetic circuits that pass through the rotor 60 when the motor 30 is energized. An insulating bracket 47 is mounted between the windings 49 and the first and second teeth 52 and 56. As shown in FIG. 7, the insulating bracket 47 includes two first insulating portions 36 for receiving the first and second teeth 52 and 56, and an second insulating portion 37 formed between the first insulating portions 36, for receiving distal ends of first and second teeth 52 and 56 respectively adjacent to the first and second arc surfaces 52a and 56a. Two stop plates 38 extend from opposite ends of each first insulating portion 36, the windings 49 are wound around the first insulating portions 36 between the corresponding stop plates 38. In this embodiment, the insulating bracket 47 includes two parts spaced from each other along an axial direction of the motor 30. A first slot 57 is defined in a first side of a top surface of the second insulating portion 37, and a second slot 58 is defined in a second side of a bottom surface of the second insulating portion 37 opposite to the first side. Hall sensors may be mounted in the first slot 57 and the second slot 58.

In this embodiment, the outer yoke portion 50 is formed by a plurality of integral magnetically conductive laminations such as silicon steel sheets stacked in an axial direction of the motor 30. In other embodiments, the outer yoke portion 50 may be joined by a first half yoke portion and a second half yoke portion.

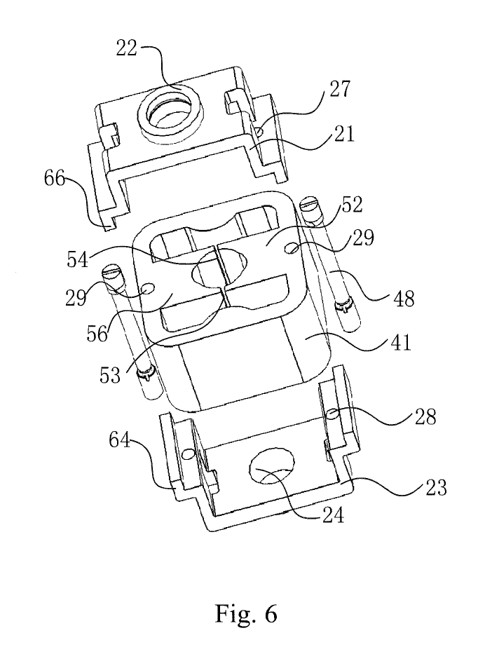

Referring to FIGS. 2 and 6, the stator 40 includes a first fixing bracket 21 and a second fixing bracket 23 mounted to opposite sides of the stator core 41 along an axial direction of the motor 30. The first fixing bracket 21 includes a first hub 22 for mounting a bearing 42. The first hub 22 is mounted to and supports the rotary shaft 61 by the bearing 42. Similarly, the second fixing bracket 23 includes a second tub 24. The second hub 24 is mounted to and supports the rotary shaft 61 by the bearing 42. Thereby, the rotor 60 is rotatably mounted to the stator 40 by the first and second fixing brackets 21 and 23. In this embodiment, each of the first and second fixing brackets 21 and 23 is substantially Q-shaped, two first through holes 27 are defined in opposite ends of the first fixing bracket 21, and two second through holes 28 are defined in opposite ends of the second fixing bracket 23. Two third through holes 29 are axially defined in opposite ends of the outer yoke portion 50 of the stator core 41. Two fasteners 48, such as positioning bolts, extend through the first through holes 27, the third through holes 29 and the second through holes 28, to fix the first and second fixing brackets 21 and 23 to the stator core 41.

In this embodiment, two right angled first bending portions 66 extend down from the opposite ends of the first fixing bracket 21, for engaging with opposite edges of the outer yoke portion 50. Similarly, two right angled second bending portions 64 extend up from the opposite ends of the second fixing bracket 23, for engaging with opposite edges of the outer yoke portion 50.

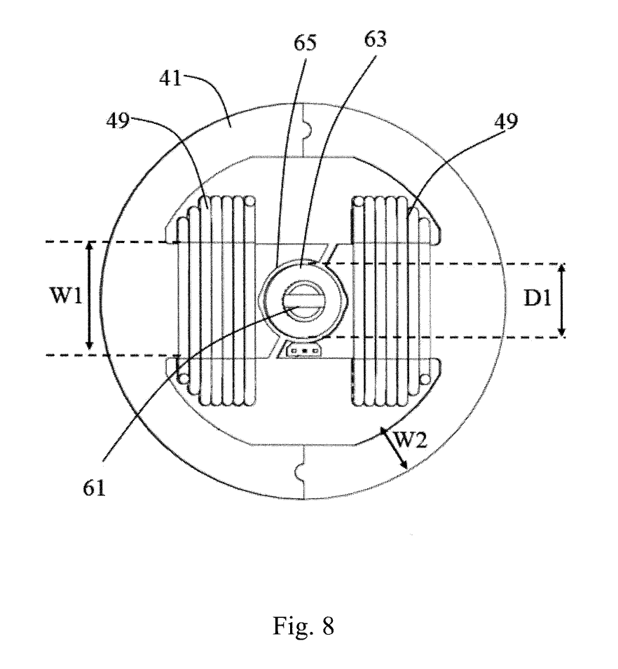

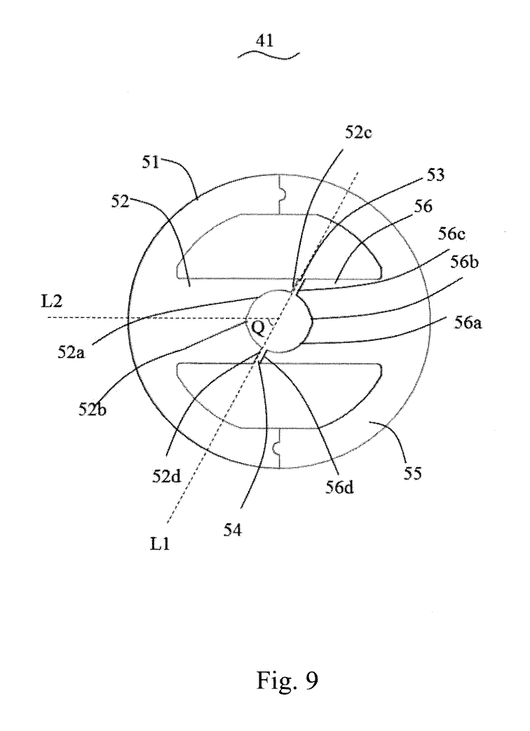

Referring to FIGS. 8 and 9, a stator core 41 of the single phase brushless motor of the power tool 200 in accordance with a second embodiment consists of a first half core portion and a second half core portion. Joining surfaces of the first half core portion and the second half core portion are provided with concave-convex inter-engagement structures. The first half core portion includes a first half yoke portion 51 and a first tooth 52 extending from the first half yoke portion 51 toward a center of the stator core. The second half core portion includes a second half yoke portion 55 and a second tooth 56 extending from the second half yoke portion 55 toward the center of the stator core. The first half yoke portion 51 and the second half yoke portion 55 cooperatively form a ring-shaped outer yoke portion 50. In this embodiment, the outer yoke portion 50 is circular. A first opening 53 and a second opening 54 with great magnetic resistance are defined between the first tooth 52 and the second tooth 56 at opposite sides of the permanent magnet 63. In this embodiment, the width W1 of the first tooth 52 and the second tooth 56 is 0.8-1.6 times of the outer diameter D1 of the rotor. The thickness W2 of the outer yoke portion 50 is 0.3-0.7 times of the outer diameter D1 of the rotor. The first tooth 52 includes a first arc surface 52a, a first positioning groove 52b is defined in the first arc surface 52a. The second tooth 56 includes a second arc surface 56a, a second positioning groove 56b is defined in the second arc surface 56a. The first positioning groove 52b and the second positioning groove 56b face to each other along a diametrical direction of the rotor, for controlling the initial/stop position of the rotor relative to the stator when the motor is de-energized. The stop position or initial position of the rotor can be adjusted by adjusting the positions of the first and second positioning grooves 52b and 56b. The first arc surface 52a and the second arc surface 56a face to each other to bound a receiving cavity therebetween for receiving the permanent magnet 63. Preferably, the first arc surface 52a and the second arc surface 56a are located on a cylindrical surface that is coaxial with the rotor, such that a substantially even air gap 65 is defined between the permanent magnet 63 and the first and second arc surfaces 52a and 56a (except for the areas of the first and second positioning grooves 52b and 56b, and the first and second openings 53 and 54, the air gap at other areas is even).

Referring to FIG. 9, more specifically, a first cutting surface 52c and a second cutting surface 52d are formed on opposite circumferential ends of the first arc surface 52a. A third cutting surface 56c and a fourth cutting surface 56d are formed on opposite circumferential ends of the second arc surface 56a. The first opening 53 is defined between the first cutting surface 52c and the third cutting surface 56c, and the second opening 54 is defined between the second cutting surface 52d and the fourth cutting surface 56d.

The width of the first opening 53 (i.e., a distance between the first cutting surface 52c and the third cutting surface 56c) is 0.09 to 0.13 times of the outer diameter D1 of the rotor, and the width of the second opening 54 (i.e., a distance between the second cutting surface 52d and the fourth cutting surface 56d) is also 0.09 to 0.13 times of the outer diameter D1 of the rotor.

Preferably, the first opening 53 and the second opening 54 are substantially the same in size and are symmetrical about the center of rotation of the rotor. A connecting line connecting the centers of the first opening 53 and the second opening 54, and the extension direction of one of the first tooth 52 and the second tooth 56 form an angle Q of 60-90 degrees. More preferably, the angle Q is 60-65 degree.

Openings of the first and second positioning grooves 52b and 56b face toward the permanent magnet 63. A width of the opening of the first positioning groove 52b and the second positioning groove 56b is 0.24 to 0.28 times of the outer diameter D1 of the rotor. The term “width of the opening” as used herein refers to a size of the first positioning groove 52b and the second positioning groove 56b along a circumferential direction of the permanent magnet. A line connecting the first positioning groove 52b and the second positioning groove 56b coincides with center lines of the first tooth 52 and the second tooth 56. In this embodiment, a center of the first positioning groove 52b is offset from a circumferential center of the first arc surface 52a, and a center of the second positioning groove 56b is deviated from a circumferential center of the second arc surface 56a. Therefore, rotor has different bidirectional startup capabilities, the motor is suitable for applications having different requirements for bidirectional startup capabilities, such as electric drill and electric screw driver.

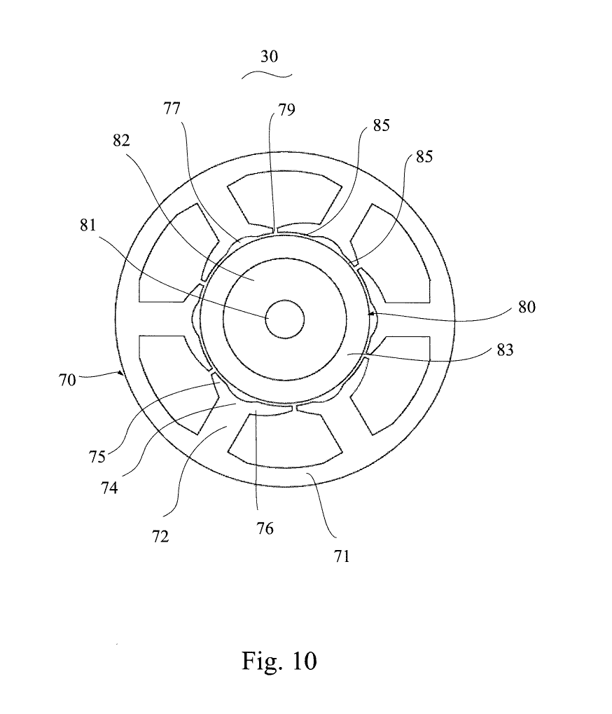

Referring to FIG. 10, the single phase brushless motor 30 of the power tool 200 in another embodiment of the present invention includes a stator 70 and a rotor 80 rotatable relative to the stator 70. The rotor 80 includes a rotary shaft 81, a rotor core 82 coupled to the rotary shaft 81, and a permanent magnet 83 coupled to the rotor core 82. The stator 70 includes a stator core and windings (not shown). The stator core includes an outer yoke portion 71 and at least two teeth 72 extending inward from the outer yoke portion 71. The teeth 72 are spaced along a circumferential direction of the outer yoke portion 71. The number of the teeth 72 may be determined according actual requirements. Each tooth 72 forms a tooth tip 74 at a distal end of the tooth 72. The windings are wound around the stator core. In this embodiment, the windings are wound around tooth bodies (located between the outer yoke portion 71 and the tooth tips 74) of the teeth 72. Each tooth tip 74 includes a first pole shoe 75 and a second pole shoe 76 extending toward two sides of the tooth 74, respectively. A length of the second pole shoe 76 along a circumferential direction of the stator is greater than a length of the first pole shoe along the circumferential direction of the stator. An arc surface is formed on an inner side of the first pole shoe 75 and the second pole shoe 76 of each tooth tip 74. A circumferential center of each arc surface deviates from a symmetry center line of the tooth body of the corresponding tooth 72. Therefore, rotor 80 has different bidirectional startup capabilities. Preferably, the arc surfaces of the teeth 72 are located on a same cylindrical surface that is coaxial with the rotor 80, an outer surface of the permanent magnet 83 is located on another cylindrical surface coaxial with the rotor 80, thereby, a substantially even air gap 85 is defined between the arc surfaces of the teeth 72 and the permanent magnet 83, which reduces the vibration and noise, makes the motor 30 operation smoother, and enhances the startup stability of the motor 30.

In this embodiment, the arc surface of each tooth 72 defines a positioning groove 77 facing the rotor 80. A center of each positioning groove 77 locates on the symmetry center line of the tooth body of the corresponding tooth 72. That is, each position groove 77 deviates from the circumferential center of the corresponding arc surface. The positioning groove 77 and the asymmetric pole shoes are configured and designed to control a stop position (i.e. an initial position) of the rotor 80 to deviate from a dead point position.

In this embodiment, in the at least two teeth 72, the second pole shoe 76 of one tooth 72 and the first pole shoe 75 of the another tooth 72 are disposed adjacent to each other with an opening 79 defined therebetween. The opening 79 has a relative large magnetic reluctance, to prevent magnetic leakage between the second pole shoe 76 and the first pole shoe 75 at two sides of the opening 79 and increase a cogging torque of the motor 30. It is to be understood that a magnetic bridge with greater magnetic reluctance can be used to replace the opening 79. Because lengths of the first pole shoe 75 and the second pole shoe 76 are different, the position of the opening 79 or the magnetic bridge deviates from a middle line between the tooth bodies of two adjacent teeth 72.

In other embodiments, the outer surface of the permanent magnet 83 and the arc surfaces of the teeth 72 may form a symmetrical uneven air gap therebetween, thereby, the waveform of the cogging torque can be sinusoidal, which make the motor 30 operate smoothly and quietly.

In this invention, the single phase blushless motor 30 of the power tool 200 has a compact structure and less windings compared with a traditional motor, which make the power tool 200 has a reduced size and reduced cost while ensuring the stable performance.

Although the invention is described with reference to one or more preferred embodiments, it should be appreciated by those skilled in the art that various modifications are possible. Therefore, the scope of the invention is to be determined by reference to the claims that follow.

1. A power tool comprising a main body and a working portion rotatably coupled to the main body, wherein a single phase brushless motor is mounted in the main body to drive the working portion to rotate bidirectionally.

2. The power tool of claim 1, wherein the single phase brushless motor has the same bidirectional startup capabilities.

3. The power tool of claim 2, wherein the single phase brushless motor comprises a stator and a rotor, the stator comprises a stator core and windings wound around the stator core, the stator core comprises an outer yoke portion and at least two teeth extending inward from the outer yoke portion, a concave arc surface is formed on a radial inner end of each tooth, the arc surfaces of the teeth cooperatively bound a cavity for receiving the rotor, a positioning groove is defined in a circumferential center of each arc surface, and each poisoning groove locates on a center line of the corresponding tooth.

4. The power tool of claim 3, wherein an opening or a magnetic bridge is formed between each two adjacent teeth, a connecting line connecting a center of the rotor and a center of the opening or magnetic bridge, and an extension direction of one of the teeth form an angle of 60-90 degrees.

5. The power tool of claim 3, wherein the circumferential width of each tooth is 0.8-1.6 times of the outer diameter of the rotor, the diametrical thickness of the outer yoke portion is 0.3-0.7 times of the outer diameter of the rotor.

6. The power tool of claim 1, wherein the single phase brushless motor has different bidirectional startup capabilities.

7. The power tool of claim 6, wherein the single phase brushless motor comprises a stator and a rotor, the stator comprises a stator core and windings wound around the stator core, the stator core comprises an outer yoke portion and at least two teeth extending inward from the outer yoke portion, a concave arc surface is formed on a radial inner end of each tooth, the arc surfaces of the teeth cooperatively bound a cavity for receiving the rotor, a positioning groove is defined in each arc surface, each poisoning groove deviates from a center line of the corresponding tooth.

8. The power tool of claim 7, wherein an opening or a magnetic bridge is formed between each two adjacent teeth, a connecting line connecting a center of the rotor and a center of the opening or magnetic bridge, and an extension direction of one of the teeth form an angle of 60-90 degrees.

9. The power tool of claim 7, wherein the circumferential width of each tooth is 0.8-1.6 times of the outer diameter of the rotor, the diametrical thickness of the outer yoke portion is 0.3-0.7 times of the outer diameter of the rotor.

10. The power tool of claim 6, wherein the single phase brushless motor comprises a stator and a rotor, the stator comprises a stator core and windings wound around the stator core, the stator core comprises an outer yoke portion and at least two teeth extending inward from the outer yoke portion, a concave arc surface is formed on a radial inner end of each tooth, the arc surfaces of the teeth cooperatively bound a cavity for receiving the rotor, a circumferential center of each arc surface deviates from a center line of the corresponding tooth.

11. The power tool of claim 10, wherein an opening or a magnetic bridge is formed between each two adjacent teeth, a connecting line connecting a center of the rotor and a center of the opening or magnetic bridge, and an extension direction of one of the teeth form an angle of 60-90 degrees.

12. The power tool of claim 10, wherein a positioning groove is defined in each arc surface, and each poisoning groove locates on a center line of the corresponding tooth.

13. The power tool of claim 1, wherein the single phase brushless motor comprises a stator and a rotor, the stator comprises a stator core and windings wound around the stator core, the stator core comprises an outer yoke portion and at least two teeth extending inward from the outer yoke portion, a concave arc surface is formed on a radial inner end of each tooth, the arc surfaces of the teeth cooperatively bound a cavity for receiving the rotor, a substantially even air gap is defined between the rotor and the arc surfaces of the teeth.

14. The power tool of claim 13, wherein an opening is defined between each two adjacent teeth, and a width of each opening is less than or equal to three times of the width of the even air gap.

15. The power tool of claim 13, wherein an opening or a magnetic bridge is formed between each two adjacent teeth, a connecting line connecting a center of the rotor and a center of the opening or magnetic bridge, and an extension direction of one of the teeth form an angle of 60-90 degrees, the circumferential width of each tooth is 0.8-1.6 times of the outer diameter of the rotor, the diametrical thickness of the outer yoke portion is 0.3-0.7 times of the outer diameter of the rotor.

16. The power tool of claim 1, wherein the single phase brushless motor comprises a stator and a rotor, the stator comprises a stator core and windings wound around the stator core, the stator core comprises an outer yoke portion and at least two teeth extending inward from the outer yoke portion, a concave arc surface is formed on a radial inner end of each tooth, the arc surfaces of the teeth cooperatively bound a cavity for receiving the rotor, a symmetrical uneven air gap is defined between the rotor and the arc surfaces of the teeth.

17. The power tool of claim 16, wherein an opening is defined between each two adjacent teeth, and a width of each opening is less than or equal to three times of the width of the uneven air gap.

18. The power tool of claim 16, wherein an opening or a magnetic bridge is formed between each two adjacent teeth, a connecting line connecting a center of the rotor and a center of the opening or magnetic bridge, and an extension direction of one of the teeth form an angle of 60-90 degrees.

19. The power tool of claim 1, wherein the single phase brushless motor comprises a stator and a rotor, the stator comprises a stator core, the stator core comprises a first tooth and a second tooth opposite to each other along a diametrical direction of the rotor, a first arc surface is formed on a radial inner end of the first tooth, a second arc surface is formed on a radial inner end of the second tooth, a first cutting surface and a second cutting surface are formed on opposite circumferential ends of the first arc surface, a third cutting surface and a fourth cutting surface are formed on opposite circumferential ends of the second arc surface, a first opening is defined between the first cutting surface and the third cutting surface, and a second opening is defined between the second cutting surface and the fourth cutting surface, the first, second, third, and fourth cutting surfaces are perpendicular or slanted relative to the extension direction of the teeth.

20. The power tool of claim 1 being an electric drill.
